(19) United States
(12) Patent Application Publication
(10) Pub. No.: US 2020/0355114 A1
(43) Pub. Date: Nov. 12, 2020

(54) ENGINE WITH MECHANICAL SUPERCHARGER

(71) Applicant: Mazda Motor Corporation, Aki-gun, Hiroshima (JP)

(72) Inventors: Shinji Fujihira, Hiroshima-shi (JP); Tsuyoshi Goto, Hiroshima-shi (JP); Ryotaro Nishida, Hiroshima-shi (JP)

(21) Appl. No.: 16/640,891

(22) PCT Filed: Aug. 25, 2017
(86) PCT No.: PCT/JP2017/030605

§ 371 Date: Feb. 21, 2020

(51) Int. Cl. F02B 67/06; F02B 39/04

(52) U.S. Cl. CPC F02B 67/06; F02D 23/005; F02B 39/04

(57) ABSTRACT

An engine includes an intake electric S-VT configured to change a rotational phase of an intake camshaft, an exhaust electric S-VT configured to change a rotational phase of an exhaust camshaft, a fuel pump, and a supercharger driven by the engine. Both the fuel pump and the supercharger are driven by power transmitted from a crankshaft. The power is transmitted to the fuel pump via a first drive mechanism, and the power is transmitted to the supercharger via a second drive mechanism whose system is different from a system of the first drive mechanism.

### TECHNICAL FIELD

The technology disclosed herein relates to an engine with a mechanical supercharger.

### BACKGROUND ART

Patent Document 1 discloses one example of an engine. Specifically, the engine disclosed in Patent Document 1 includes a camshaft and a fuel pump configured to be able to adjust a fuel pressure so as to inject high-pressure fuel. The fuel pump is configured to be driven by receiving power transmitted from an engine output shaft (crankshaft) of the engine. The power is transmitted by a drive mechanism having a first chain serving as an endless transmission member on a side adjacent to an end (a side adjacent to the rear) of the engine output shaft.

Furthermore, the drive mechanism described in Patent Document 1 includes a second chain wound between the fuel pump and the camshaft, separately from the first drive chain wound between one end of the engine output shaft and the fuel pump. Therefore, when the engine is operated, the power is transmitted to the fuel pump via the first drive chain and is transmitted to the camshaft via the second drive chain.

### CITATION LIST

### Patent Document

PATENT DOCUMENT 1: Japanese Unexamined Patent Publication No. 2016-205241

### SUMMARY OF THE INVENTION

### Technical Problem

Heretofore, the fuel pump has been directly attached to one end (for example, a rear end) of the camshaft to be coupled to the camshaft. In addition to the fuel pump, when a variable valve mechanism for changing a rotational phase of the camshaft is included, such a variable valve mechanism also has been attached to the above-mentioned one end.

On the other hand, for example, in an engine capable of executing compression ignition combustion, it may be required to inject high-pressure fuel in order to shorten penetration (a reach distance of a spray tip) of fuel spray and promote, e.g., cooling of gas by atomization promotion.

However, when the high-pressure fuel is injected, a driving load required for operating the fuel pump becomes relatively large in accordance with a fuel pressure. In this case, considering that resistance upon changing a rotational phase of the camshaft increases in accordance an increase in a driving load, in order to ensure responsiveness of the variable valve mechanism, it is conceivable to disperse the driving load by connecting the engine output shaft and the fuel pump together via the first drive chain and connecting the fuel pump and the camshaft together via the second drive chain, for example, as described in the aforementioned Patent Document 1, instead of directly attaching the fuel pump to the aforementioned one end.

In a case where a mechanical supercharger is further used with such an engine, it is required to take into consideration of a driving load required for operating the mechanical supercharger. For this reason, for example, if the fuel pump and the mechanical supercharger share the drive mechanism, a driving load of the entire drive mechanism becomes large, which is disadvantageous in ensuring the responsiveness of the variable valve mechanism.

In addition, as described above, if the fuel pump and the mechanical supercharger share the drive mechanism, a load may be concentrated on a predetermined portion of the engine output shaft. Then, unevenness of the load occurs, which is disadvantageous in ensuring reliability of the engine output shaft. In this case, in order to ensure the reliability of the engine output shaft, the size of a bearing is needed to be increased, for example. However, it is not desirable because fuel economy is deteriorated due to an increase in mechanical resistance.

The technology disclosed herein has been devised in view of the aforementioned problems, and it is an object thereof to provide a technique of, in an engine with a mechanical supercharger, substantially preventing driving performance of a fuel pump and a mechanical supercharger from interfering each other without concentrating a load applied to an engine output shaft while ensuring responsiveness of a variable valve mechanism.

### Solution to the Problems

The technology disclosed herein relates to an engine with a mechanical supercharger, comprising: an engine provided with a camshaft and an injector; a variable valve mechanism mounted on the camshaft and configured to change a rotational phase of the camshaft; a fuel pump configured to regulate a pressure of fuel injected from the injector; and a mechanical supercharger driven by the engine.

Both the fuel pump and the mechanical supercharger are driven by power transmitted from an engine output shaft of the engine. The power is transmitted to the fuel pump via a first drive mechanism, and the power is transmitted to the mechanical supercharger via a second drive mechanism whose system is different from a system of the first drive mechanism.

This configuration allows the fuel pump and the mechanical supercharger to be respectively driven by drive mechanisms whose systems are different from each other. Thus, a driving load required for operating the fuel pump and the mechanical supercharger can be dispersed, thereby allowing responsiveness of the variable valve mechanism to be ensured.

In addition, by making the systems of the drive mechanism for transmitting the power to the fuel pump and the drive mechanism for transmitting the power to the mechanical supercharger different from each other without making those drive mechanisms in common with each other, a load applied to the engine output shaft can be dispersed and thus, reliability thereof can be ensured. At the same time, driving performance of the fuel pump and the mechanical supercharger can be substantially prevented from interfering with each other.

As described above, according to the above-described configuration, while the responsiveness of the variable valve mechanisms is ensured, it is made possible to substantially prevent the driving performance of the fuel pump and the mechanical supercharger from interfering with each other without concentrating the load applied to the engine output shaft.

Furthermore, as described above, the systems of the drive mechanism for the fuel pump and the drive mechanism for the mechanical supercharger are made different from each other without making those drive mechanisms in common with each other, thereby leading to advantage in ensuring layout performance of the drive mechanisms, as compared with, for example, a configuration in which those drive mechanisms are driven by the same system.

Moreover, as described above, when high-pressure fuel is injected, a driving load required for operating the fuel pump becomes relatively large in accordance with a fuel pressure. Therefore, the above-mentioned configuration allows the driving load applied to the fuel pump to increase, thereby making it possible to inject fuel having a higher pressure. In particular, in a compression ignition type engine, this is effective in shortening penetration of fuel spray, in promoting cooling of the gas or the like by atomization promotion, and in enhancing emission performance, fuel consumption performance, and output performance.

In addition, the fuel pump may be configured to set the pressure of the fuel to be 40 MPa or more.

In this configuration, the fuel pump sets a higher fuel pressure than that of the conventional fuel pump. As already described, the above-mentioned configuration is effective upon injecting the fuel having the higher pressure since by making the systems of the drive mechanism for the fuel pump and the drive mechanism for the mechanical supercharger different from each other without making those drive mechanisms in common with each other, it becomes permissible to increase the driving load applied to the fuel pump.

Furthermore, the first drive mechanism and the fuel pump may be drive-coupled to each other on one side adjacent to an end (hereinafter referred to as “one end side”) of the engine output shaft, and the second drive mechanism and the mechanical supercharger may be drive-coupled to each other on the other end side of the engine output shaft.

This configuration allows a load applied to the engine output shaft to be dispersed toward one end and the other end, which is advantageous in ensuring reliability of the engine output shaft.

Moreover, the first drive mechanism may include a one-end-side endless transmission member wound around one end of the engine output shaft and the fuel pump.

Here, the one-end-side endless transmission member may be an endless timing belt or a timing chain.

In addition, the first drive mechanism may include a second one-end-side endless transmission member that is configured to transmit power to the camshaft and that is apart from the other-end-side endless transmission member.

This configuration allows a driving load required for operating the fuel pump and the camshaft to be dispersed to the one-end-side endless transmission member and the second one-end-side endless transmission member in the first drive mechanism. Thus, reliability of the respective members can be ensured.

Moreover, the second drive mechanism may include an other-end-side endless transmission member wound around the other end of the engine output shaft and the mechanical supercharger.

Here, the other-end-side endless transmission member may be an endless timing belt or a timing chain as with the one-end-side endless transmission member.

In addition, the second drive mechanism may include a second other-end-side endless transmission member that is configured to transmit power to a compressor of an air conditioner and that is apart from the other-end-side endless transmission member.

This configuration allows a drive load required for operating the mechanical supercharger and the compressor to be dispersed to the other-end-side endless transmission member and the second other-end-side endless transmission member in the second drive mechanism. Thus, reliability of the respective belts can be ensured.

Moreover, a configuration in which the air conditioner is driven by the second drive mechanism allows for reducing a drive load in the first drive mechanism, and thus, ensuring reliability of the first drive mechanism.

In addition, a geometric compression ratio of the engine may be 15 or more.

Furthermore, the injector may be configured to inject fuel containing at least gasoline directly into a cylinder of the engine.

According to this configuration, the engine can be the so-called gasoline engine.

### Advantages of the Invention

As described above, in the above-described engine with a mechanical supercharger, while the responsiveness of the variable valve mechanisms is ensured, it is made possible to substantially prevent the driving performance of the fuel pump and the mechanical supercharger from interfering with each other without concentrating the load applied to the engine output shaft.

### BRIEF DESCRIPTION OF THE DRAWINGS

FIG. 1 is a schematic diagram illustrating an example of a configuration of an engine.

FIG. 2 is a diagram illustrating the engine, viewed from front.

FIG. 3 is a diagram illustrating the engine, viewed from above.

FIG. 4 is a perspective view showing a partial configuration of the engine.

FIG. 5 is a diagram schematically illustrating a first drive mechanism.

FIG. 6 is a diagram schematically illustrating a second drive mechanism.

### DESCRIPTION OF EMBODIMENTS

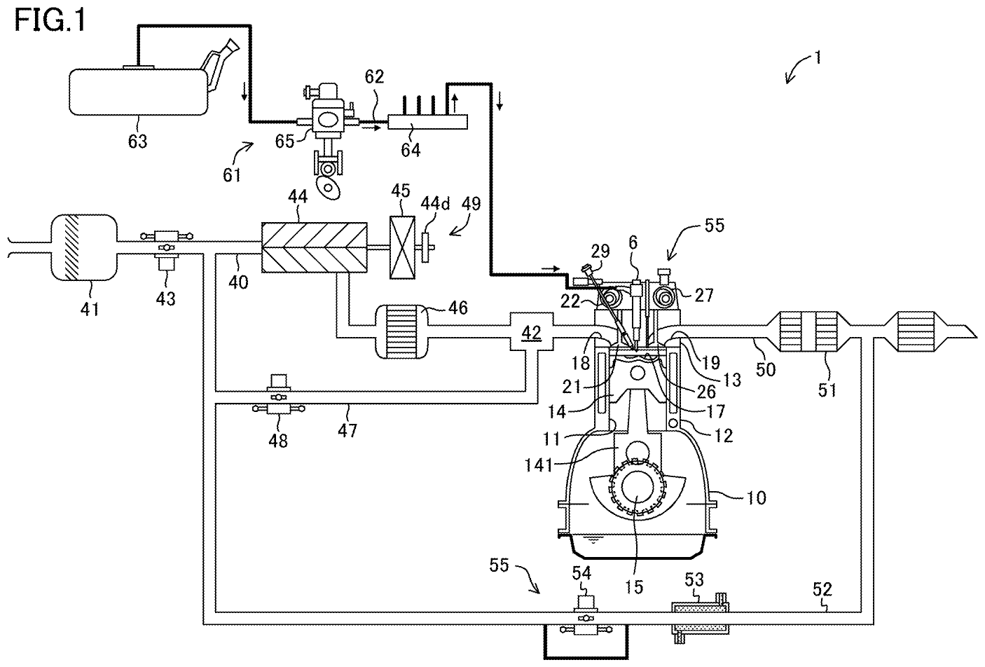

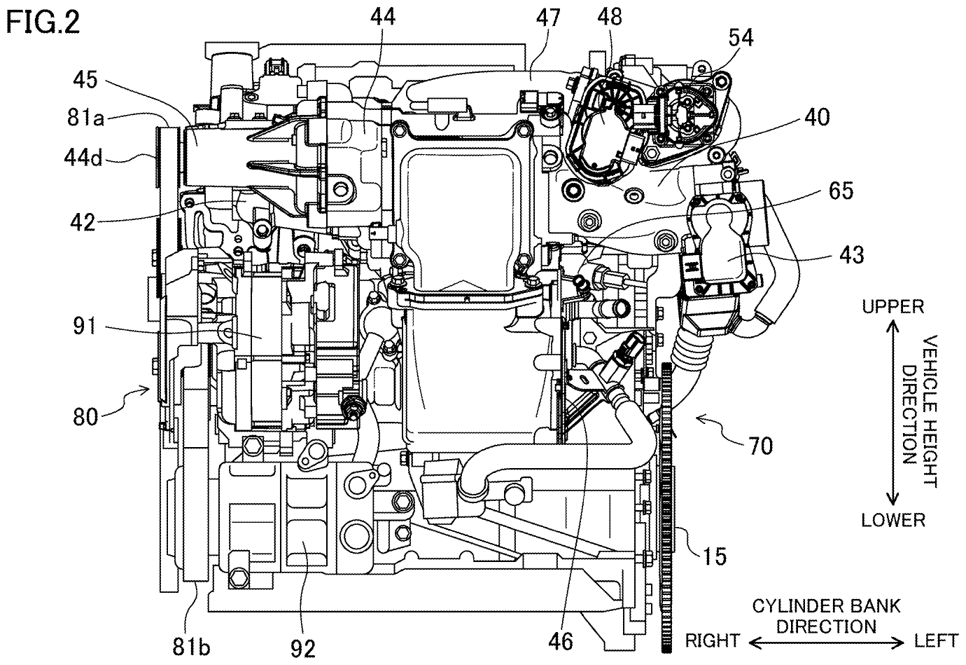

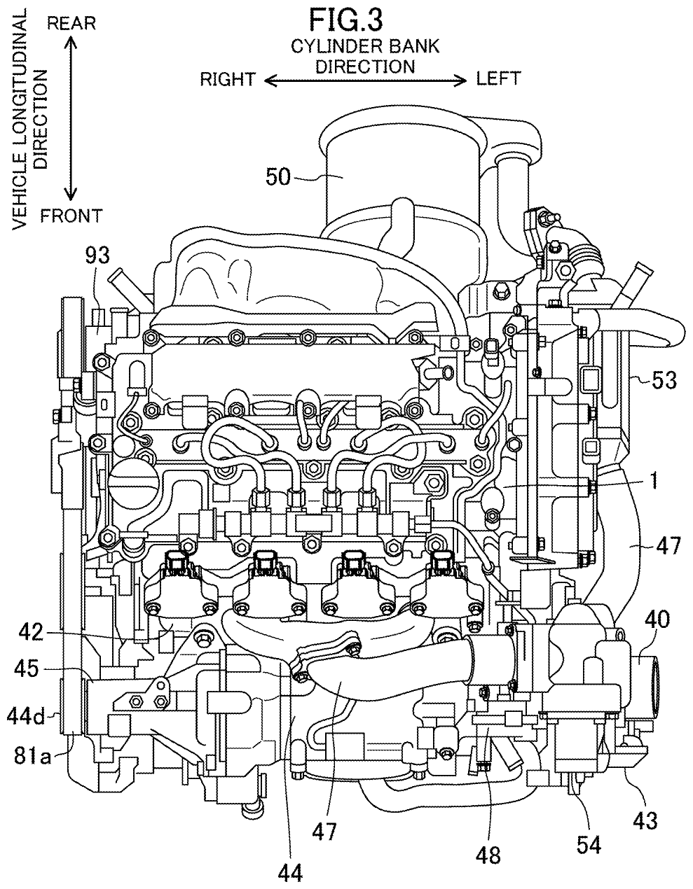

Hereinafter, embodiments of an engine with a mechanical supercharger will be described in detail with reference to the accompanying drawings. Note that the following description is merely illustrative. FIG. 1 is a schematic diagram illustrating a configuration of an engine (hereinafter, simply referred to as an “engine”) 1 with a mechanical supercharger disclosed herein. FIG. 2 is a diagram illustrating the engine 1, viewed from front, and FIG. 3 is a diagram illustrating the engine 1, viewed from above.

The engine 1 is a four-stroke type internal combustion engine mounted on a four-wheel vehicle and as shown in FIG. 1, is configured to include a mechanically driven supercharger (mechanical supercharger) 44. Fuel for the engine 1 is high-octane gasoline (the octane number of the fuel is approximately 96) in this example of the configuration. The fuel may be gasoline that contains bioethanol. The fuel for the engine 1 may be any fuel as long as the fuel is liquid fuel which contains at least gasoline.

In particular, in this example of the configuration, the engine 1 can perform both spark ignition (SI) combustion and compression ignition (CI) combustion. Here, the SI combustion is combustion initiated by ignition of air-fuel mixture in a combustion chamber. In contrast, the CI combustion is combustion initiated by compression autoignition of the air-fuel mixture in the combustion chamber.

The engine 1 is a so-called in-line four-cylinder transverse engine including four cylinders 11 arranged in line along the vehicle width. In this configuration, the engine longitudinal direction, along which the four cylinders 11 are arranged (along a cylinder bank), is substantially the same as the vehicle width direction, while the engine width direction is substantially the same as the vehicle longitudinal direction.

Note that in the in-line multi-cylinder engine, the cylinder bank direction, a direction along which a central axis of a crankshaft 15 serving as an engine output shaft extends (engine output axis direction), and a direction along which a central axes of an intake camshaft 22 and exhaust camshaft 27 coupled to the crankshaft 15 coincide with one another. In the following description, these directions may be collectively referred to as the cylinder bank direction (or the vehicle width direction).

Hereinafter, unless otherwise specified, a front side refers to a front side in the vehicle longitudinal direction, a rear side refers to a rear side in the vehicle longitudinal direction, a left side refers to one side in the vehicle width direction (one side in the cylinder bank direction), and a right side refers to the other side in the vehicle width direction (the other side in the cylinder bank direction and the front side of the engine).

In addition, in the following description, an upper side refers to an upper side in a vehicle height direction, with the engine 1 mounted in the vehicle (hereinafter, also referred to as an “in-vehicle mounted state), and a lower side refers to a lower side in the vehicle height direction in the in-vehicle mounted state.

(Outline of Configuration of Engine)

In this example of the configuration, the engine 1 is of a front-intake and rear-exhaust type. Specifically, the engine 1 includes: an engine body 10 having the four cylinders 11; an intake passage 40 located in front of the engine body 10 and communicating with the respective cylinders 11 via intake ports 18; and an exhaust passage 50 located behind the engine body 10 and communicating with the respective cylinders 11 via exhaust ports 19.

The intake passage 40 is configured to allow gas (fresh air) introduced from outside to pass therethrough and supply the gas into each of the cylinders 11 of the engine body 10. In this example of the configuration, the intake passage 40 includes a plurality of passages for introducing the gas and devices such as a supercharger 44 and an intercooler 46, all of which are combined as a unit in front of the engine body 10.

The engine body 10 is configured to combust a mixture of the fuel and the gas supplied from the intake passage 40 in the cylinders 11. Specifically, the engine body 10 includes a cylinder block 12 and a cylinder head 13 placed above the cylinder block 12. Power generated by combusting the air-fuel mixture is delivered to the outside via the crankshaft 15 provided in the cylinder block 12.

Inside the cylinder block 12, the above-mentioned four cylinders 11 are formed. The four cylinders 11 are arranged in line along the central axis of the crankshaft 15 (along the cylinder bank). Note that in FIG. 1, only one of the cylinders 11 is illustrated.

In each of the cylinders 11, a piston 4 is slidably inserted. The piston 14 is coupled to the crankshaft 15 via a connecting rod 141. The piston 14 defines a combustion chamber 17 together with each of the cylinders 11 and the cylinder head 13. Note that the “combustion chamber” here is not limited to a space defined when the piston 14 reaches a compression top dead center. The term “combustion chamber” is used to encompass a broader meaning.

A geometric compression ratio of the engine body 10 is determined in accordance with a shape of the combustion chamber 17. In this example of the configuration, the geometric compression ratio is 15 to 18 in order to obtain high-octane gasoline. Note that in the case of an engine having a regular specification (the octane number of fuel is approximately 91), it may be set to 14 to 17.

The cylinder head 13 has two intake ports 18 provided for each cylinder 11. FIG. 1 illustrates only one of the intake ports 18. The two intake ports 18 are adjacent to each other in the cylinder bank direction and communicate with the respective cylinders 11.

Each of the two intake ports 18 is provided with an intake valve 21. The intake valve 21 opens and closes a portion between the combustion chamber 17 and each of the intake ports 18. The intake valve 21 is opened and closed by an intake valve mechanism at predetermined timing.

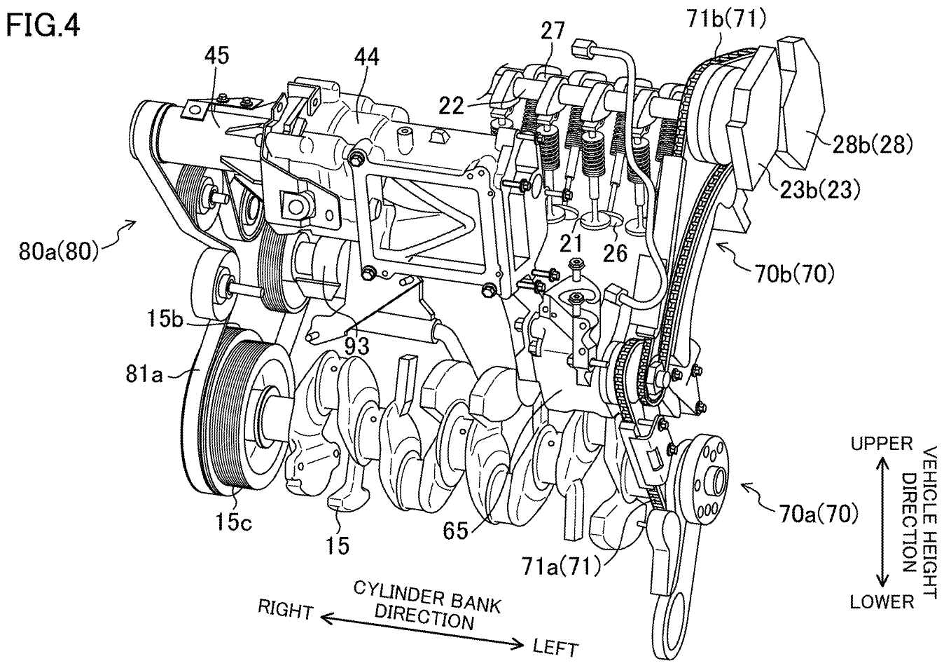

In this example of the configuration, the intake valve mechanism includes an intake camshaft (see also FIG. 4) 22 for operating the intake valve 21 and an intake electric S-VT (Sequential-Valve Timing) 23 attached to the intake camshaft 22 and configured to change a rotational phase of the intake camshaft 22. The intake electric S-VT 23 is an example of a “variable valve mechanism.”

The intake camshaft 22 is provided inside the cylinder head 13 and is pivotally supported in a posture in which the direction of the central axis of the intake camshaft 22 substantially coincides with the engine output axis direction. The intake camshaft 22 is coupled to the crankshaft 15 via a chain type first drive mechanism 70. The first drive mechanism 70 revolves the intake camshaft 22 once while the crankshaft 15 revolves twice, as is well known in the art.

The intake electric S-VT 23 is configured to continuously change a rotational phase of the intake camshaft 22 within a predetermined angle range so as to make at least one of valve timing and valve lift of the intake valve 21 variable. Thus, valve opening timing and valve closing timing of the intake valve 21 change continuously. Note that the intake valve mechanism may include a hydraulic type S-VT, instead of the intake electric S-VT 23.

The cylinder head 13 also has two exhaust ports 19 provided for each cylinder 11. In FIG. 1, only 1 exhaust port 19 is illustrated. The two exhaust ports 19 are adjacent to each other in the cylinder bank direction and communicate with the respective cylinders 11.

Each of the two exhaust ports 19 is provided with an exhaust valve 26. The exhaust valve 26 opens and closes a portion between the combustion chamber 17 and each of the exhaust ports 19. The exhaust valve 26 is opened and closed by an exhaust valve mechanism at predetermined timing.

In this example of the configuration, the exhaust valve mechanism includes an exhaust camshaft 27 (see also FIG. 4) for operating the exhaust valve 26 and an exhaust electric S-VT 28 attached to the exhaust camshaft 27 and configured to change a rotational phase of the exhaust camshaft 27. The exhaust electric S-VT 28 is also an example of a “variable valve mechanism.”

The exhaust camshaft 27 is provided inside the cylinder head 13 and is pivotally supported in such a way as to have a posture in parallel with the intake camshaft 22. The exhaust camshaft 27 is coupled to the crankshaft 15 via the above-mentioned first drive mechanism 70. While the crankshaft 15 revolves twice, the exhaust camshaft 27 revolves once.

The exhaust electric S-VT 28 is configured to be similar to the intake electric S-VT 23 and continuously adjusts valve opening timing and valve closing timing of the exhaust valve 26 by changing a rotational phase of the exhaust camshaft 27. Note that the exhaust valve mechanism may include a hydraulic S-VT, instead of the electric S-VT 28.

The cylinder head 13 has an injector 6 provided for each cylinder 11. The injector 6 is configured to inject fuel, including at least gasoline, directly into each of the cylinders 11 (specifically, into the combustion chamber 17). In this exemplary configuration, the injector 6 is a multi-nozzle-port type fuel injection valve.

A fuel supply system 61 is connected to the injector 6. The fuel supply system 61 is configured to allow fuel pressurized by a fuel pump 65 to be supplied to the injector 6.

The fuel supply system 61 includes a fuel tank 63 configured to store fuel and a fuel supply passage 62 connecting the fuel tank 63 and the injector 6 to each other. The fuel supply passage 62 is interposed between the fuel pump 65 and a common rail 64.

The fuel pump 65 is configured to adjust a pressure of the fuel injected from the injector 6. In this exemplary configuration, the fuel pump 65 is a plunger type pump driven by power transmitted from the crankshaft 15 and is configured to pumps out the fuel to the common rail 64.

Note that the fuel pump 65 is configured to allow the pressure of the fuel to be set to at least 40 MPa or more, preferably 60 MPa or more, and more preferably 80 MPa or more. The highest fuel pressure in the fuel supply system 61 may be, for example, approximately 120 MPa. The pressure of fuel to be supplied to the injector 6 may be changed in accordance with an operation state of the engine 1.

The common rail 64 is configured to store the fuel pumped out from the fuel pump 65 at a high fuel pressure. When the injector 6 opens, the fuel stored in the common rail 64 is injected from a nozzle port of the injector 6 into the combustion chamber 17.

Note that the highest fuel pressure in the fuel supply system 61 may be, for example, approximately 120 MPa. The pressure of fuel to be supplied to the injector 6 may be changed in accordance with an operation state of the engine 1. Note that the configuration of the fuel supply system 61 is not limited to the above-described configuration.

The cylinder head 13 has spark plugs 29 provided for each cylinder 11. The spark plug 29 has a tip protruding into the combustion chamber 17, so that the tip forcibly ignites the air-fuel mixture inside the combustion chamber 17.

In returning to the description of the intake passage 40, the intake passage 40 in this example of the configuration is connected to one side surface (specifically, a side surface on a front side) of the engine body 10 and communicates with the intake ports 18 of the cylinders 11.

An air cleaner 41 filtering the fresh air is provided to an upstream end of the intake passage 40. On the other hand, in the vicinity of a downstream end of the intake passage 40, a surge tank 42 is provided. A portion, of the intake passage 40, located downstream of the surge tank 42 constitutes independent passages which respectively branch off for the cylinders 11. A downstream end of each of the independent passages is connected to the intake port 18 of a corresponding one of the cylinders 11, respectively.

A throttle valve 43 is provided between the air cleaner 41 and the surge tank 42 in the intake passage 40. An opening of the throttle valve 43 is adjusted to regulate the amount of fresh air to be introduced into the combustion chamber 17.

In the intake passage 40, the supercharger 44 is provided downstream of the throttle valve 43. The supercharger 44 is configured to supercharge the gas to be introduced into the combustion chamber 17. In this exemplary configuration, the supercharger 44 is a mechanical supercharger driven by the engine 1 (specifically, by power transmitted from the crankshaft 15), i.e., a Roots supercharger. The supercharger 44 may have any given configuration. The supercharger 44 may be of, for example, a Lysholm type, a vane type, or a centrifugal type.

An electromagnetic clutch 45 is interposed between the supercharger 44 and the crankshaft 15. The electromagnetic clutch 45 transmits and blocks driving force between the supercharger 44 and the crankshaft 15. A control means (not shown) such as an engine control unit (ECU) switches disconnection and connection of the electromagnetic clutch 45 to turn on and off the supercharger 44. Specifically, this engine 1 is configured to allow switching between an operation mode of supercharging the gas to be introduced into the combustion chamber 17 and an operation mode of not supercharging the gas to be introduced into the combustion chamber 17 to be performed by turning on and off the supercharger 44.

Note that the supercharger 44 is coupled to the crankshaft 15 via a belt type second driving mechanism 80. As described later, a system of the second drive mechanism 80 is separated from a system of the above-described first drive mechanism 70.

Specifically, the supercharger 44 includes: a pair of rotors (not shown), each of which has a rotating shaft extending along the cylinder bank; and a supercharger drive pulley 44d which rotationally drives the rotors. The supercharger 44 is coupled to the crankshaft 15 via a timing belt 81 wound around the supercharger drive pulley 44d. The above-mentioned electromagnetic clutch 45 is interposed between the supercharger drive pulley 44d and the rotors.

The intercooler 46 is provided downstream of the supercharger 44 in the intake passage 40. The intercooler 46 is configured to cool the gas compressed in the supercharger 44. The intercooler 46 may be of, for example, a water cooling type.

In addition, a bypass passage 47 is connected to the intake passage 40. The bypass passage 47 connects an upstream portion of the supercharger 44 and a downstream portion of the intercooler 46 in the intake passage 40 to each other so as to bypass the supercharger 44 and the intercooler 46. An air bypass valve 48 is provided for the bypass passage 47. The air bypass valve 48 regulates a flow rate of gas which flows in the bypass passage 47.

When the supercharger 44 is turned off (that is, when the electromagnetic clutch 45 is disconnected), the air bypass valve 48 fully opens. Thus, the gas flowing in the intake passage 40 bypasses the supercharger 44 and is introduced into the combustion chamber 17 of the engine 1. The engine 1 is operated without supercharging, that is, by natural intake.

When the supercharger 44 is turned on (that is, when the electromagnetic clutch 45 is connected), an opening degree of the air bypass valve 48 is adjusted as appropriate. At this time, a part of gas, which has passed through the supercharger 44, flows back to the upstream side of the supercharger 44 through the bypass passage 47. A rate of the backflow gas can be regulated by adjusting an opening degree of the air bypass valve 48. Therefore, the rate of the backflow gas allows regulation of a supercharging pressure of the gas to be introduced into the combustion chamber 17. In this exemplary configuration, supercharger 44, the bypass passage 47, and the air bypass valve 48 constitutes a supercharging system 49.

On the other hand, the exhaust passage 50 is connected to another side surface of the engine body 10 (specifically, a side surface on a rear side) and communicates with the exhaust ports 19 of the cylinders 11. The exhaust passage 50 is a passage through which exhaust gas discharged from the combustion chamber 7 flows. Although detailed illustration is omitted, an upstream portion of the exhaust passage 50 forms independent passages, which branch off for the respective cylinders 11. An upstream end of each of the independent passages is connected to a corresponding one of the exhaust ports 19 of the cylinders 11.

The exhaust passage 50 is provided with an exhaust gas purification system including a plurality of catalyst converters 51. Each of the catalyst converters 51 includes a three-way catalyst. Note that the exhaust gas purification system is not limited to an exhaust gas purification system including the three-way catalysts.

An EGR passage 52 constituting an external EGR system is connected between the intake passage 40 and the exhaust passage 50. The EGR passage 52 is a passage for returning part of the combusted gas into the intake passage 40. Specifically, an upstream end of the EGR passage 52 is connected to a portion adjacent to the catalyst converter 51 in the exhaust passage 50. On the other hand, a downstream end of the EGR passage 52 is connected to a portion upstream of the supercharger 44 in the intake passage 40.

The EGR passage 52 is provided with a water cooling type EGR cooler 53. The EGR cooler 53 is configured to cool the combusted gas. The EGR passage 52 is also provided with an EGR valve 54. The EGR valve 54 is configured to regulate a flow rate of the combusted gas flowing through the EGR passage 52. By adjusting an opening degree of the EGR valve 54, the cooled combusted gas, that is, a recirculating flow rate of the external EGR gas can be regulated.

In this example of the configuration, an EGR system 55 is comprised of: the external EGR system including the EGR passage 52 and the EGR valve 54; and the internal EGR system including the intake electric S-VT 23 and the exhaust electric S-VT 28 described above.

The engine 1 is provided with various auxiliary machines in addition to the above-described fuel pump 65. The engine 1 includes an alternator 91 for generating an alternating current for use in an electrical system, an air conditioner 92 for air conditioning, and a water pump 93 for circulating cooling water as the auxiliary machines.

Here, as shown in FIG. 2, the fuel pump 65 is attached to a front portion of the engine body 10 on a left end side thereof (see also FIG. 4). On the other hand, the alternator 91 and the air conditioner 92 are attached to a front portion of the engine body 10 on a right end side thereof, whereas the water pump 93 is attached to a rear portion of the engine body 10 on a right end side thereof (see FIGS. 3 to 4). The alternator 91 and the air conditioner 92 are arranged in this order from above.

(Configurations of First and Second Drive Mechanisms)

Hereinafter, configurations of the first and second drive mechanisms 70 and 80 will be described in detail.

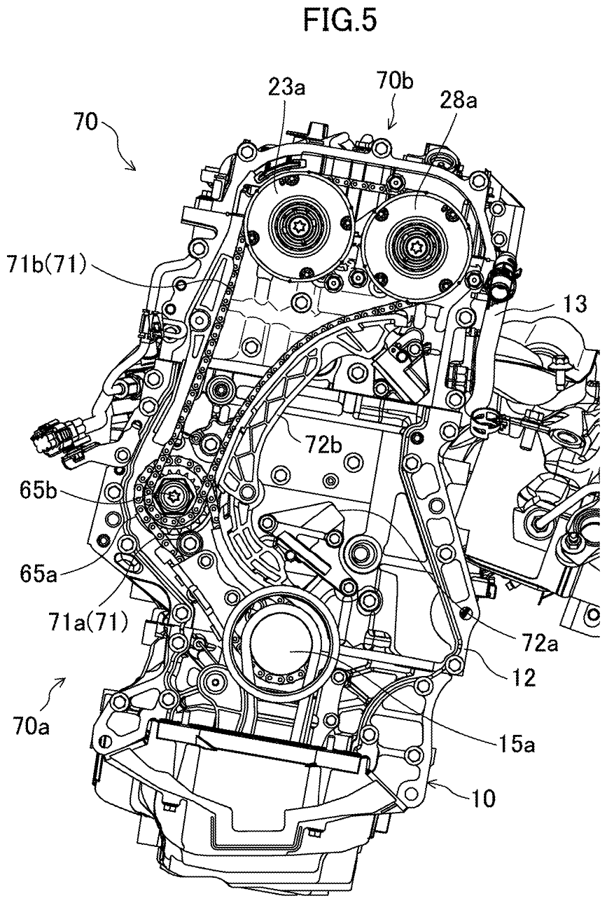

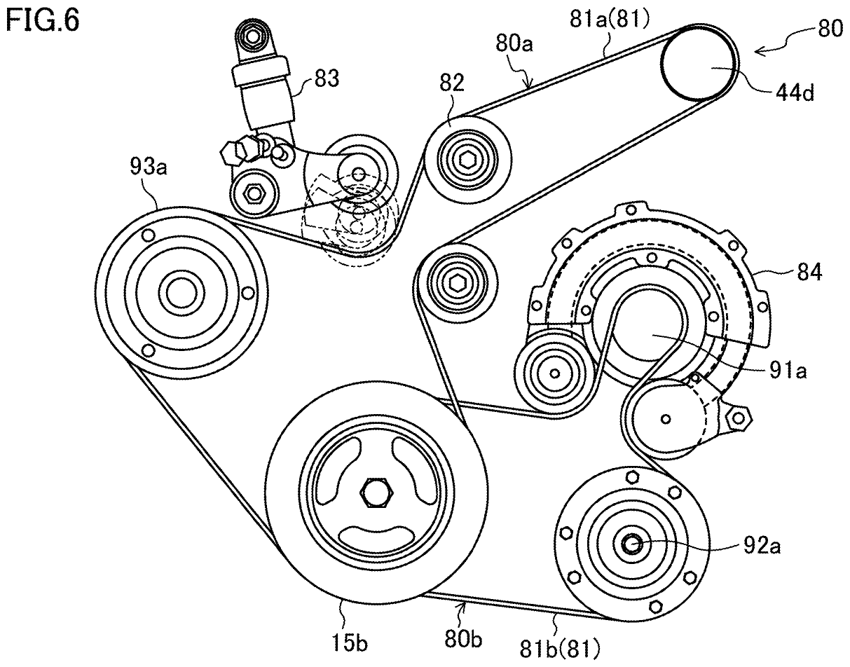

FIG. 4 is a perspective view illustrating a partial configuration of the engine 1. In FIG. 4, members constituting the engine 1, such as the cylinder block 12, are partially omitted to show the configurations of the first drive mechanism 70 and the second drive mechanism 80. FIG. 5 is a diagram schematically illustrating the first drive mechanism 70, and FIG. 6 is a diagram schematically illustrating the second drive mechanism 80.

As described above, both the fuel pump 65 and the supercharger 44 are driven by the power transmitted from the crankshaft 15 of the engine 1. Here, whereas the power is transmitted to the fuel pump 65 via the first drive mechanism 70, the power is transmitted to the supercharger 44 via the second drive mechanism 80 whose system is different from that of the first drive mechanism 70.

More specifically, as shown in FIG. 4, whereas the first drive mechanism 70 is disposed on one end side (left end side) in the cylinder bank direction, the second drive mechanism 80 is disposed on the other end side (right end side) in the cylinder bank direction. By adopting such a disposition, the systems of the first drive mechanism 70 and the second drive mechanism 80 are different from each other.

Whereas the first drive mechanism 70 and the fuel pump 65 are drive-coupled to each other on the left end side of the crankshaft 15, the second drive mechanism 80 and the supercharger 44 are drive-coupled to each other on the right end side of the crankshaft 15.

Hereinafter, the configuration of the first drive mechanism 70 and the configuration of the second drive mechanism 80 will be described in order.

—First Drive Mechanism—

As shown in FIG. 5, the first drive mechanism 70 is a gear drive mechanism using a timing chain 71 and is provided on a left side surface of the engine 1. The first drive mechanism 70 is configured to operate the intake valve 21 via the intake camshaft 22, operate the exhaust valve 26 via the exhaust camshaft 27, and drive the above-described fuel pump 65.

Specifically, the first drive mechanism 70 includes a first chain mechanism 70a for driving the fuel pump 65 and a second chain mechanism 70b for driving the intake camshaft 22 and the exhaust camshaft 27.

The first drive mechanism 70 also includes two chains which are a first chain 71a for transmitting power in the first chain mechanism 70a and a second chain 71b for transmitting power in the second chain mechanism 70b as timing chains 71. Note that the first chain 71a is an example of the “one-end-side endless transmission member”, and the second chain 71b is an example of the “second one-end-side endless transmission member.”

Specifically, the first chain mechanism 70a includes a first sprocket 15a provided in a left end (one end) of the crankshaft 15, a second sprocket 65a provided in a left end of the fuel pump 65, the above-mentioned first chain 71a wound between the first sprocket 15a and the second sprocket 65a, and a first auto-tensioner 72a for applying tension to the first chain 71a.

Specifically, as can be seen from FIG. 5, the first sprocket 15a is located below the cylinder block 12 in the vehicle height direction and is located adjacent to a central portion of the cylinder block 12 in the vehicle longitudinal direction.

On the other hand, the second sprocket 65a is located adjacent to a central portion of the cylinder block 12 in the vehicle height direction and is located in front of the cylinder block 12 in the vehicle longitudinal direction.

Furthermore, the second chain mechanism 70b includes a third sprocket 65b provided on a left side and an inner circumferential side of the second sprocket 65a in the fuel pump 65, a sprocket gear 23a provided in the intake electric S-VT 23, a sprocket gear 28a provided in the exhaust electric S-VT 28, a second chain 71b wound between the third sprocket 65b and the sprocket gears 23a and 28a, and a second auto-tensioner 72b for applying tension to the second chain 71b.

Specifically, as with the second sprocket 65a, the third sprocket 65b is located in a central portion of the cylinder block 12 in the vehicle height direction and is located in a front end of the cylinder block 12 in the vehicle longitudinal direction.

In returning to the description of the intake electric S-VT 23, as shown in FIG. 4, the intake electric S-VT 23 is attached in a left side of the intake camshaft 22 and protrudes leftward with respect to a left side surface of the cylinder head 13. In addition, as shown in FIG. 5, the intake electric S-VT 23 is located in the vicinity of an upper end of the cylinder head 13 in the vehicle height direction, while being located behind the cylinder head 13 in the vehicle longitudinal direction.

Although detailed illustration is omitted, the intake electric S-VT 23 includes the sprocket gear 23a around which the second chain 71b is wound and which rotates in conjunction with the crankshaft 15, a camshaft gear which rotates in conjunction with the intake camshaft 22, a planetary gear for adjusting a rotational phase of the camshaft gear relative to the sprocket gear 23a, and an S-VT motor 23b for driving the planetary gear. The S-VT motor 23b is provided at the left end of the intake electric S-VT 23.

On the other hand, the exhaust electric S-VT 28 is attached to a left side of the exhaust camshaft 27 and is adjacent to the intake electric S-VT 23 in front as can be seen from FIG. 5. The exhaust electric S-VT 28 is also configured to include the sprocket gear 28a and an S-VT motor 28b.

Accordingly, the sprocket gears 23a and 28a are disposed in such a way as to be located in the vicinity of an upper end of the cylinder head 13 in the vehicle height direction and to be adjacent to each other in a front and rear direction in the vehicle longitudinal direction, as with the intake electric S-VT 23 and the exhaust electric S-VT 28.

When the crankshaft 15 is rotated, the power is outputted from the first sprocket 15a to rotate the second sprocket 65a via the first chain 71a. Then, the power is transmitted to the fuel pump 65, and the fuel pump 65 is driven by the power.

On the other hand, when the power transmitted from the crankshaft 15 rotates the second sprocket 65a, the third sprocket 65b of the fuel pump 65 is also rotated. Then, the power is transmitted to the sprocket gears 28a and 23a via the second chain 71b. The transmitted power rotates the intake camshaft 22 and the exhaust camshaft 27. Thus, the intake valve 21 and the exhaust valve 26 are operated.

—Second Drive Mechanism—

As shown in FIG. 6, the second drive mechanism 80 is a belt drive mechanism using a timing belt 81 and is provided on a right side surface of the engine 1. The second drive mechanism 80 is configured to operate the supercharger 44 via the supercharger drive pulley 44d, while driving the above-mentioned alternator 91, air conditioner 92, and water pump 93.

More specifically, the second drive mechanism 80 includes a first belt mechanism 80a for driving the supercharger 44 and the water pump 93 and a second belt mechanism 80b for driving the alternator 91 and the air conditioner 92.

The second drive mechanism 80 also includes two belts, namely, a first belt 81a for transmitting power in the first belt mechanism 80a and a second belt 81b for transmitting power in the second belt mechanism 80b, as timing belts 81. Note that the first belt 81a is an example of the “other-end-side endless transmission member”, and the second belt 81b is an example of the “second other-end-side endless transmission member.”

Specifically, as shown in FIGS. 4 and 6, the first belt mechanism 80a includes a first crankshaft pulley 15b provided in a right end (the other end) of the crankshaft 15, a water pump drive pulley 93a provided in a right end of the water pump 93, a plurality of driven pulleys (not shown in detail) such as an idle pulley 82, a supercharger drive pulley 44d, the above-mentioned first belt 81a which is wound around the first crankshaft pulley 15b, the water pump drive pulley 93a, the plurality of driven pulleys, and the supercharger drive pulley 44d, and a hydraulic auto-tensioner 83 for applying tension to the first belt 81a.

On the other hand, as shown in FIG. 6, the second belt mechanism 80b includes a second crankshaft pulley 15c (see FIG. 4) provided adjacent to a left side of the first crankshaft pulley 15b in the crankshaft 15, an alternator drive pulley 91a provided in a right end of the alternator 91, an air conditioner drive pulley 92a provided in the compressor of the air conditioner 92, the above-mentioned second belt 81b which is wound around the second crankshaft pulley 15c, the alternator drive pulley 91a, and the air conditioner drive pulley 92a, and a double arm tensioner 84 for applying tension to the second belt 81b.

Accordingly, when the crankshaft 15 rotates, the power is outputted from the first crankshaft pulley 15b to rotate the water pump drive pulley 93a and the supercharger drive pulley 44d via the first belt 81a. Then, the power is transmitted to the water pump 93 and the supercharger 44, and each of the water pump 93 and the supercharger 44 is driven by the power.

On the other hand, when the crankshaft 15 rotates, the power is also outputted from the second crankshaft pulley 15c to rotate the alternator drive pulley 91a and the air conditioner drive pulley 92a via the second belt 81b. Then, power is transmitted to the alternator 91 and the compressor of the air conditioner 92, and each of the alternator 91 and the compressor of the air conditioner 92 is driven by the power.

### CONCLUSION

As described above, in the fuel pump 65 and the supercharger 44, the power is transmitted by the drive mechanisms whose systems are different from each other as shown in FIG. 4. Since a drive load required for operating the fuel pump 65 and the supercharger 44 can be dispersed, responsiveness of the intake electric S-VT 23 and the exhaust electric S-VT 28 can be ensured without hindering the operations of the S-VT motors 23b and 28b, as compared with, for example, the configuration in which both the fuel pump 65 and the supercharger 44 are driven by the first drive mechanism 70.

Furthermore, by making the systems of the first drive mechanism 70 for transmitting the power to the fuel pump 65 and the second drive mechanism 80 for transmitting the power to the supercharger 44 different from each other without making the first drive mechanism 70 and the second drive mechanism 80 in common with each other, the load applied to the crankshaft 15 can be dispersed and thus, reliability of the crankshaft 15 can be ensured. At the same time, driving performance of the fuel pump 65 and the supercharger 44 can be substantially prevented from interfering with each other.

As described above, while the responsiveness of the intake electric S-VT 23 and the exhaust electric S-VT 28 is ensured, it is made possible to prevent the driving performance of the fuel pump 65 and the supercharger 44 from interfering with each other without concentrating the load applied to the crankshaft 15.

In addition, as shown in FIG. 4, by making the systems of the first drive mechanism 70 for the fuel pump 65 and the second drive mechanism 80 for the supercharger 44 different from each other without making the first drive mechanism 70 and the second drive mechanism 80 in common with each other, it is advantageous in ensuring layout performance of the first and second drive mechanisms 70 and 80 as a whole, as compared with, for example, a configuration in which the first drive mechanism 70 and the second drive mechanism 80 are driven by the same system.

Furthermore, as described above, when the high-pressure fuel is injected, the driving load required for operating the fuel pump 65 becomes relatively large in accordance with the fuel pressure. Therefore, the configuration shown in FIG. 4 allows the driving load of the fuel pump 65 to increase, thereby making it possible to inject fuel having a higher pressure. In particular, in a compression ignition type engine, this is effective in shortening penetration of fuel spray, in promoting cooling of the gas or the like by atomization promotion, and in enhancing emission performance, fuel consumption performance, and output performance.

Moreover, as shown in FIG. 4, whereas on the left end side of the crankshaft 15, the first drive mechanism 70 and the fuel pump 65 are drive-coupled to each other, on the right end side of the crank shaft 15, the second drive mechanism 80 and the supercharger 44 are drive-coupled to each other. The above-mentioned configuration allows the load applied to the crankshaft 15 to be dispersed to the left end side and the right end side, which is advantageous in ensuring reliability of the crankshaft 15.

In addition, as shown in FIG. 5, in the first drive mechanism 70, the drive load required for operating the fuel pump 65 and the intake and exhaust camshafts 22 and 27 can be dispersed to the first chain 71a and the second chain 71b. Thus, reliability of the timing chain 71 can be ensured.

Furthermore, as shown in FIG. 6, in the second drive mechanism 80, the driving load required for operating the supercharger 44 and the compressor of the air conditioner 92 can be dispersed to the first belt 81a and the second belt. Thus, reliability of the timing belt 81 can be ensured.

In addition, the configuration in which the air conditioner 92 is driven by the second drive mechanism 80 allows for reducing a drive load in the first drive mechanism 70, and thus, ensuring reliability of the first drive mechanism 70.

### Other Embodiments

In the above-described embodiment, the first drive mechanism 70 is the gear drive mechanism using the timing chain 71 and the second drive mechanism 80 is the belt drive mechanism using the timing belt 81. However, the present invention is not limited to this configuration. For example, both the first drive mechanism 70 and the second drive mechanism 80 may be belt drive mechanisms.

In addition, in the above-described embodiment, the intake electric S-VT 23 and the exhaust electric S-VT 28 as the variable valve mechanisms are configured to be one element of the first drive mechanism 70. However, the present invention is not limited to this configuration. For example, the intake electric S-VT 23 and the exhaust electric S-VT 28 may be one element of the second drive mechanism 80.

### DESCRIPTION OF REFERENCE CHARACTERS

1 Engine
6 Injector
11 Cylinder
15 Crankshaft (Engine Output Shaft)
22 Intake Camshaft (Camshaft)
23 Intake Electric S-VT (Variable Valve Mechanism)
27 Exhaust Camshaft (Camshaft)
28 Exhaust Electric S-VT (Variable Valve Mechanism)
44 Supercharger (Mechanical Supercharger)
65 Fuel Pump
70 First Drive Mechanism
71 Timing Chain
71a First Chain (One-end-side Endless Transmission Member)
71b Second Chain (Second One-end-side Endless Transmission Member)
80 Second Drive Mechanism
81 Timing Belt
81a First Belt (Other-end-side Endless Transmission Member)
81b Second Belt (Second Other-end-side Endless Transmission Member)

1. An engine with a mechanical supercharger, comprising: an engine provided with a camshaft and an injector; a variable valve mechanism mounted on the camshaft and configured to change a rotational phase of the camshaft; a fuel pump configured to regulate a pressure of fuel injected from the injector; and a mechanical supercharger driven by the engine,
both the fuel pump and the mechanical supercharger being driven by power transmitted from an engine output shaft of the engine,
the power being transmitted to the fuel pump via a first drive mechanism and the power being transmitted to the mechanical supercharger via a second drive mechanism whose system is different from a system of the first drive mechanism.

2. The engine with a mechanical supercharger, of claim 1, wherein
the fuel pump is configured to set the pressure of the fuel to be 40 MPa or more.

3. The engine with a mechanical supercharger, of claim 1, wherein
the first drive mechanism and the fuel pump are drive-coupled to each other on one end side of the engine output shaft, and the second drive mechanism and the mechanical supercharger are drive-coupled to each other on the other end side of the engine output shaft.

4. The engine with a mechanical supercharger, of claim 3, wherein
the first drive mechanism includes a one-end-side endless transmission member wound around one end of the engine output shaft and the fuel pump.

5. The engine with a mechanical supercharger, of claim 4, wherein
the first drive mechanism includes a second one-end-side endless transmission member that is configured to transmit power to the camshaft and that is apart from the one-end-side endless transmission member.

6. The engine with a mechanical supercharger, of claim 3, wherein
the second drive mechanism includes an other-end-side endless transmission member wound around the other end of the engine output shaft and the mechanical supercharger.

7. The engine with a mechanical supercharger, of claim 6, wherein
the second drive mechanism includes a second other-end-side endless transmission member that is configured to transmit power to a compressor of an air conditioner and that is apart from the other-end-side endless transmission member.

8. The engine with a mechanical supercharger, of claim 1, wherein
a geometric compression ratio of the engine is 15 or more.

9. The engine with a mechanical supercharger, of claim 1, wherein
the injector is configured to inject fuel containing at least gasoline directly into a cylinder of the engine.
